(19) United States
(12) Patent Application Publication
(10) Pub. No.: US 2019/0386302 A1
(43) Pub. Date: Dec. 19, 2019

(54) LITHIUM-ION RECHARGEABLE BATTERY AND POSITIVE ELECTRODE ACTIVE MATERIAL

(71) Applicant: SHOWA DENKO K.K., Tokyo (JP)

(72) Inventors: Takaki YASUDA, Ichihara-shi (JP); Akira SAKAWAKI, Ichihara-shi (JP); Tatsunori SHINO, Ichihara-shi (JP)

(73) Assignee: Showa Denko K.K., Tokyo (JP)

(21) Appl. No.: 16/479,244

(22) PCT Filed: Dec. 1, 2017
(86) PCT No.: PCT/JP2017/043335

§ 371 Date: Jul. 19, 2019

(30) Foreign Application Priority Data
Jan. 20, 2017 (JP) 2017-008442

(51) Int. Cl. H01M 4/505; H01M 4/131; H01M 10/0525; H01M 10/0562

(52) U.S. Cl. CPC H01M 4/505; H01M 4/131; H01M 2300/0071; H01M 10/0562; H01M 10/0525

(57) ABSTRACT

A lithium-ion rechargeable battery (1) composed of a positive electrode layer (20), a solid electrolyte layer (30), a negative electrode layer (40) and a negative electrode collector layer (50) that are stacked on a substrate (10). The positive electrode layer (20) is made of lithium manganate (Li_{2.5}Mn₂O₄) having a lithium molar ratio higher than that of a stoichiometric composition.

### TECHNICAL FIELD

The present invention relates to a lithium-ion rechargeable battery and a positive electrode active material.

### BACKGROUND ART

With widespread use of portable electronics, such as mobile phones and laptop computers, a strong need exists for small and lightweight rechargeable batteries with a high energy density. Known examples of the rechargeable batteries meeting such a need include lithium-ion rechargeable batteries. The lithium-ion rechargeable battery includes: a positive electrode containing a positive electrode active material that occludes and releases lithium under positive polarity; a negative electrode containing a negative electrode active material that occludes and releases lithium under negative polarity; and an electrolyte exhibiting lithium ionic conductivity and disposed between the positive electrode and the negative electrode.

Patent Document 1 discloses using lithium manganate as an active material in the lithium-ion rechargeable battery.

### CITATION LIST

### Patent Literature

Patent Document 1: Japanese Patent Application Laid-Open Publication No. 2016-152159

### SUMMARY OF INVENTION

### Technical Problem

The lithium-ion rechargeable battery is strongly required to have an as small as possible inner resistance and increase its battery capacity deliverable to an external device per charge.

However, an all-solid lithium-ion rechargeable battery, which does not use an electrolyte liquid, may contain a region with low lithium ionic conductivity at an interface between a solid electrolyte and a positive electrode. This may lower a discharge capacity of the all-solid lithium-ion rechargeable battery as compared to a battery using an electrolyte liquid.

An object of the present invention is to increase the discharge capacity of the all-solid lithium-ion rechargeable battery.

### Solution to Problem

A lithium-ion rechargeable battery of the present invention includes, in the following order: a positive electrode layer containing lithium, manganese and oxygen, the positive electrode layer having a lithium molar ratio higher than a lithium molar ratio of a stoichiometric composition, the positive electrode layer occluding and releasing lithium ions; an electrolyte layer containing an electrolyte that exhibits lithium ionic conductivity; and a negative electrode layer occluding and releasing lithium ions under a polarity opposite to a polarity of the positive electrode layer.

In the positive electrode layer of the above lithium-ion rechargeable battery, lithium may be at a higher molar ratio to manganese.

Further, the positive electrode layer may have an amorphous structure.

From another aspect, a lithium-ion rechargeable battery of the present invention includes, in the following order: a positive electrode layer containing lithium, manganese and oxygen, the positive electrode layer occluding and releasing lithium ions; an electrolyte layer containing an electrolyte that exhibits lithium ionic conductivity; and a negative electrode layer occluding and releasing lithium ions under a polarity opposite to a polarity of the positive electrode layer, wherein a molar ratio of lithium to manganese in a portion of the positive electrode layer facing the electrolyte layer is higher than a molar ratio of lithium to manganese in another portion of the positive electrode layer not facing the electrolyte layer.

In the above lithium-ion rechargeable battery, a lithium molar ratio in the portion of the positive electrode layer facing the electrolyte layer may be higher than a lithium molar ratio of a stoichiometric composition.

From still another aspect, a lithium-ion rechargeable battery of the present invention includes, in the following order: a positive electrode layer including a first positive electrode layer and a second positive electrode layer, the first positive electrode layer containing lithium, manganese and oxygen, the second positive electrode layer containing lithium, manganese and oxygen with a different composition from the first positive electrode layer, the positive electrode layer occluding and releasing lithium ions; an electrolyte layer provided on the second positive electrode layer of the positive electrode layer, the electrolyte layer containing an electrolyte exhibiting lithium ionic conductivity; and a negative electrode layer occluding and releasing lithium ions under a polarity opposite to a polarity of the positive electrode layer, wherein the second positive electrode layer has a lithium molar ratio higher than a lithium molar ratio of a stoichiometric composition.

In the second positive electrode layer of the above lithium-ion rechargeable battery, lithium may be at a higher molar ratio to manganese.

Further, a molar ratio of lithium to manganese in the second positive electrode layer may be higher than a molar ratio of lithium to manganese in the first positive electrode layer.

Further, the first positive electrode layer may have a lithium molar ratio lower than the lithium molar ratio of a stoichiometric composition.

From yet another aspect, a positive electrode active material of the present invention contains lithium, manganese, and oxygen, and has a lithium molar ratio higher than a lithium molar ratio of a stoichiometric composition.

In the above positive electrode active material, lithium may be at a higher molar ratio to manganese.

### Advantageous Effects of Invention

The present invention allows to increase a discharge capacity of an all-solid lithium-ion rechargeable battery.

### BRIEF DESCRIPTION OF DRAWINGS

FIG. 1 depicts a cross-sectional structure of a lithium-ion rechargeable battery of the first embodiment;

FIG. 2 shows analysis results on the valence of Mn of Li_{1.5}Mn₂O₄ and Li_{2.5}Mn₂O₄ using EELS (electron energy loss spectroscopy);

FIG. 3 is a flowchart depicting a method for manufacturing the lithium-ion rechargeable battery of the first embodiment;

FIG. 4 depicts the cross-sectional structure of a lithium-ion rechargeable battery of the second embodiment;

FIG. 5 depicts X-ray diffraction patterns of lithium-ion rechargeable batteries of Example 2 and a comparative example and a substrate; and

FIG. 6 depicts charge-discharge curves of the lithium-ion rechargeable batteries of Example 1, Example 2, and the comparative example.

### DESCRIPTION OF EMBODIMENTS

Embodiments of the present invention will be described in detail below with reference to the attached drawings. In the drawings as referred to in the below description, dimensions of each component, including size and thickness, may differ from actual ones.

### First Embodiment

### [Structure of the Lithium-Ion Rechargeable Battery]

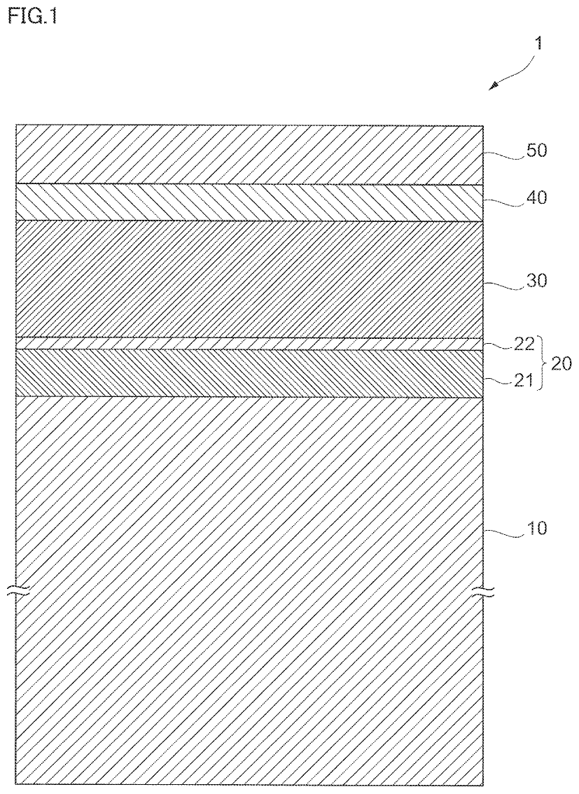

FIG. 1 depicts a cross-sectional structure of a lithium-ion rechargeable battery 1 of the first embodiment.

The lithium-ion rechargeable battery 1 of the present embodiment includes: a substrate 10; a positive electrode layer 20 stacked on the substrate 10; a solid electrolyte layer 30 stacked on the positive electrode layer 20; a negative electrode layer 40 stacked on the solid electrolyte layer 30; and a negative electrode collector layer 50 stacked on the negative electrode layer 40. The positive electrode layer 20 includes: a first positive electrode layer 21 stacked on the substrate 10; and a second positive electrode layer 22 stacked on the first positive electrode layer 21. The solid electrolyte layer 30 is stacked on this second positive electrode layer 22.

The above constituents of the lithium-ion rechargeable battery 1 will be described in more detail below.

### (Substrate)

The substrate 10 is not limited to a particular material, and may be made of any of various materials including metal, glass, and ceramics.

In the present embodiment, the substrate 10 is made of a metal sheet having electron conductivity in order that the substrate 10 also functions as a positive electrode collector layer of the lithium-ion rechargeable battery 1. More specifically, the substrate 10 of the present embodiment is made of a stainless foil (sheet), which has a higher mechanical strength than copper, aluminum etc. Alternatively, the substrate 10 may be made of a metal foil plated with conductive metal such as tin, copper, and chromium. When the substrate 10 is made of a material having insulation properties, a positive electrode collector layer having electron conductivity may be disposed between the substrate 10 and the positive electrode layer 20.

The substrate 10 may have a thickness of 20 μm or more and 200 μm or less, for example. With a thickness of less than 20 μm, the substrate 10 is prone to pin holes or breakage during rolling or heat sealing for manufacture of the metal foil, and has a high electric resistance value when used as the positive electrode. Meanwhile, with a thickness of more than 200 μm, the substrate 10 reduces its volume energy density and weight energy density due to increase in battery thickness and weight, and such a thickness also reduces flexibility of the lithium-ion rechargeable battery 1.

### (Positive Electrode Layer)

The positive electrode layer 20 is a solid thin film, and each of the first positive electrode layer 21 and the second positive electrode layer 22 includes a positive electrode active material containing lithium (Li), manganese (Mn), and oxygen (O). More specifically, the positive electrode layer 20 of the present embodiment is made of lithium manganate (LiₓMn_{y}O_{z}). The positive electrode layer 20 releases lithium ions during a charge and occludes lithium ions during a discharge.

Materials of the positive electrode layer 20 are not limited to those described above, and the positive electrode layer 20 may contain other substances, examples of which include one or more metals selected from natrium (Na), potassium (K), magnesium (Mg), calcium (Ca), strontium (Sr), barium (Ba), scandium (Sc), yttrium (Y), titanium (Ti), zirconium (Zr), hafnium (Hf), vanadium (V), niobium (Nb), tantalum (Ta), chromium (Cr), molybdenum (Mo), tungsten (W), rhenium (Re), iron (Fe), ruthenium (Ru), cobalt (Co), rhodium (Rh), iridium (Ir), nickel (Ni), palladium (Pd), platinum (Pt), copper (Cu), silver (Ag), gold (Au), zinc (Zn), cadmium (Cd), mercury (Hg), aluminum (Al), gallium (Ga), indium (In), thallium (Tl), germanium (Ge), tin (Sn), lead (Pb), antimony (Sb) and bismuth (Bi), and one or more non-metals selected from nitrogen (N), phosphorus (P), sulfur (S), selenium (Se), tellurium (Te), fluorine (F), chlorine (Cl), bromine (Br) and iodine (I). The positive electrode layer 20 may also be a composite positive electrode containing a solid electrolyte.

As described above, the substrate 10 of the present embodiment also functions as a positive electrode collector layer, and thus the positive electrode layer 20 (the first positive electrode layer 21 and the second positive electrode layer 22) is directly stacked on the substrate 10. When the substrate 10 is made of an insulator, a positive electrode collector layer (not shown in the figure) is staked on the substrate 10, and then the positive electrode layer 20 is staked on this positive electrode collector layer.

### First Positive Electrode Layer

The first positive electrode layer 21 of the present embodiment is made of lithium manganate (LiₓMn_{y}O_{z}). In the first positive electrode layer 21, lithium is at a lower molar ratio to manganese (x<y). More specifically, the first positive electrode layer 21 of the present embodiment is made of Li_{1.5}Mn₂O₄ (x=1.5, y=2, Z=4). Here, Li_{1.5}Mn₂O₄ (Li:Mn=1.5:2) has a higher molar ratio of lithium to manganese than LiMn₂O₄ (Li:Mn=1:2), which is used as a positive electrode active material, and has a lower molar ratio of lithium to manganese than Li₂Mn₂O₄ (Li:Mn=2:2), which is used as a positive electrode active material. Also, Li_{1.5}Mn₂O₄ constituting the first positive electrode layer 21 does not have a stoichiometric composition, unlike these LiMn₂O₄ and Li₂Mn₂O₄.

The first positive electrode layer 21 preferably has a thickness of 100 nm or more and 40 μm or less, for example. With the first positive electrode layer 21 having a thickness of less than 100 nm, the lithium-ion rechargeable battery 1 obtained therefrom has a too small capacity, which makes the lithium-ion rechargeable battery 1 impracticable. Meanwhile, with the first positive electrode layer 21 having a thickness of more than 40 μm, it takes too much time to form the layer, which reduces productivity. The first positive electrode layer 21 may, however, have a thickness of more than 40 μm when a large battery capacity is required of the lithium-ion rechargeable battery 1.

The first positive electrode layer 21 may have a crystalline structure or a non-crystalline, amorphous structure. The first positive electrode layer 21 is, however, preferably amorphous because the amorphous structure allows for more isotropic expansion and contraction when lithium ions are occluded and released.

While any known deposition method may be used to manufacture the first positive electrode layer 21, such as various PVD (physical vapor deposition) and CVD (chemical vapor deposition) methods, it is preferable to use a sputtering method (sputtering) in terms of production efficiency.

### (Second Positive Electrode Layer)

The second positive electrode layer 22 of the present embodiment is also made of lithium manganate (LiₓMn_{y}O_{z}). Contrary to the above first positive electrode layer 21, lithium is at a higher molar ratio to manganese (x>y) in the second positive electrode layer 22. More specifically, the second positive electrode layer 22 of the present embodiment is made of Li_{2.5}Mn₂O₄ (x=2.5, y=2, Z=4). Here, Li_{2.5}Mn₂O₄ (Li:Mn=2.5:2) has a higher molar ratio of lithium to manganese than LiMn₂O₄ (Li:Mn=1:2) and Li₂Mn₂O₄ (Li:Mn=2:2), which are generally used as a positive electrode active material. Also, Li_{2.5}Mn₂O₄ constituting the second positive electrode layer 22 does not have a stoichiometric composition, similarly to Li_{1.5}Mn₂O₄ constituting the first positive electrode layer 21.

The second positive electrode layer 22 preferably has a thickness of 100 nm or more and 200 nm or less, for example. With the second positive electrode layer 22 having a thickness of less than 100 nm, it is difficult to lower the internal resistance of the lithium-ion rechargeable battery 1 obtained therefrom. Such a thickness also makes the obtained lithium-ion rechargeable battery 1 prone to surge in the battery voltage and resultant failures when the lithium-ion rechargeable battery 1 is CCCV (constant current constant voltage)-charged. Meanwhile, with the second positive electrode layer 22 having a thickness of more than 200 nm, it is unable to improve ionic conductivity of the positive electrode layer 20 as a whole.

The second positive electrode layer 22 may have a crystalline structure or a non-crystalline, amorphous structure. The second positive electrode layer 22 is, however, preferably amorphous because the amorphous structure allows for more isotropic expansion and contraction when lithium ions are occluded and released.

While any known deposition method may be used to manufacture the second positive electrode layer 22, such as various PVD (physical vapor deposition) and CVD (chemical vapor deposition) methods, it is preferable to use a sputtering method (sputtering) in terms of production efficiency.

### (Relationship Between the First Positive Electrode Layer and the Second Positive Electrode Layer)

In the present embodiment, the second positive electrode layer 22 has a higher molar ratio of lithium to manganese than that of the first positive electrode layer 21. More specifically, in the present embodiment, the first positive electrode layer 21 is made of Li_{1.5}Mn₂O₄, whereas the second positive electrode layer 22 is made of Li_{2.5}Mn₂O₄. As such, the first positive electrode layer 21 and the second positive electrode layer 22 have different lithium/manganese molar ratios, and preferably the lithium/manganese molar ratio of the second positive electrode layer 22 is higher than that of the first positive electrode layer 21.

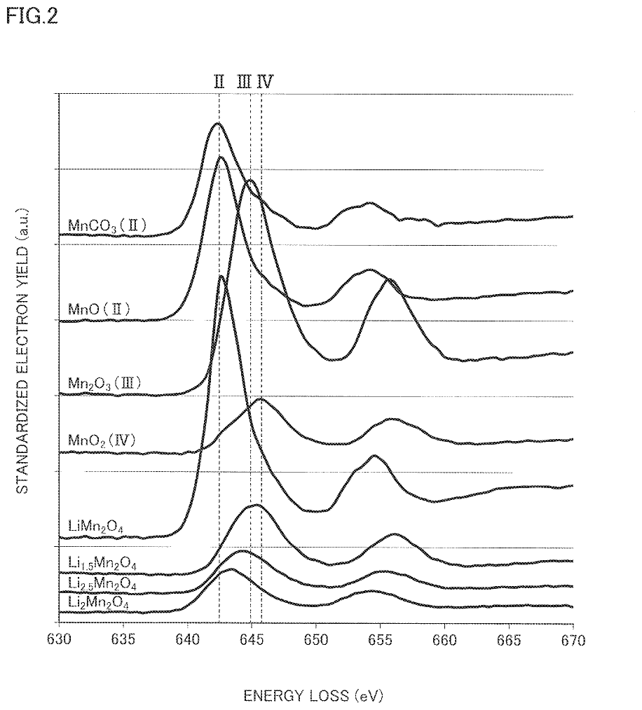

FIG. 2 shows analysis results on the valence of Mn of Li_{1.5}Mn₂O₄ and Li_{2.5}Mn₂O₄ using EELS (electron energy loss spectroscopy). In FIG. 2, the horizontal axis represents energy loss (eV), and the vertical axis represents standardized electron yield (a.u.). FIG. 2 also shows analysis results of MnCO₃ (Mn:bivalent (denoted as “II”)), MnO (Mn:bivalent), Mn₂O₃ (Mn:trivalent (denoted as “III”)), MnO₂ (Mn:quadrivalent (denoted as “IV”)), LiMn₂O₄, and Li₂Mn₂O₄. Bivalent Mn has its peak around 643 (eV), trivalent Mn has its peak around 645 (eV), and quadrivalent Mn has its peak around 646 (eV).

FIG. 2 shows that both of Li_{1.5}Mn₂O₄ and Li_{2.5}Mn₂O₄ contain trivalent Mn. Stoichiometrically, Li_{1.5}Mn₂O₄ is considered Li-poor with Li being 0.5 mol lower than that of Li₂Mn₂O₄, which is a stoichiometric composition. Also, Li_{2.5}Mn₂O₄ is considered Li-rich with Li being 0.5 mol higher than that of Li₂Mn₂O₄.

Facing the second positive electrode layer 22, which has a higher lithium molar ratio than that of the stoichiometric composition, with the solid electrolyte layer 30 allows to reduce interface resistance between the positive electrode layer 20 and the solid electrolyte layer 30. When the positive electrode layer 20 is crystalline, it is considered difficult to realize an Li-rich state. On the other hand, making the positive electrode layer 20 amorphous is considered advantageous for realizing an Li-rich state.

Also, Li_{1.5}Mn₂O₄, which is Li-poor, includes Li ionic vacancies. Thus, using Li_{1.5}Mn₂O₄ for the first positive electrode layer 21 improves Li ionic conductivity of the positive electrode layer 20.

Lithium manganate with the composition formula of Li₂MnO₃ is also used as a positive electrode active material, and the valence of this Mn is quadrivalent. Li_{2.5}MnO₃, which has a lithium molar ratio higher than that of the stoichiometric composition, may be used as the second positive electrode layer 22 of the present embodiment.

The thickness of the second positive electrode layer 22 is preferably smaller than that of the first positive electrode layer 21. Even if the second positive electrode layer 22 has a higher thickness than that of the first positive electrode layer 21, it has no contribution to reduction in the internal resistance of the lithium-ion rechargeable battery 1, which leads to a failure to increase ionic conductivity of the positive electrode layer 20 including the second positive electrode layer 22.

In the present embodiment, the positive electrode layer 20 consists of the two layers of the first positive electrode layer 21 and the second positive electrode layer 22. However, the positive electrode layer 20 may consist of three or more stacked layers each having a different lithium/manganese molar ratio, for example. In the present embodiment, the molar ratio of lithium to manganese in the positive electrode layer 20 is changed stepwise by composing it of the first positive electrode layer 21 and the second positive electrode layer 22. The molar ratio of lithium to manganese may, however, be continuously changed in the thickness direction, for example. In this case, the molar ratio of lithium to manganese in a portion of the positive electrode layer 20 facing the solid electrolyte layer 30 may be made higher than that in another portion of the positive electrode layer 20 facing the substrate 10 (i.e., the portion not facing the solid electrolyte layer 30).

### (Solid Electrolyte Layer)

The solid electrolyte layer 30, which is an example of the electrolyte layer, may be a solid thin film that is made of an inorganic material (inorganic solid electrolyte) and exhibits lithium ionic conductivity. As long as these conditions are met, the solid electrolyte layer 30 is not limited to a particular material, and may be made of any of various materials including an oxide, a nitride, and a sulfide. In the present embodiment, LiPON (LiₐPO_{b}N_{c}), which is prepared by replacing a part of oxygen in Li₃PO₄ with nitrogen, is used as the solid electrolyte layer 30.

The solid electrolyte layer 30 may have a thickness of 10 nm or more and 10 μm or less, for example. With the solid electrolyte layer 30 having a thickness of less than 10 nm, the lithium-ion rechargeable battery 1 obtained therefrom is prone to a short circuit (leakage) between the positive electrode layer 20 and the negative electrode layer 40. Meanwhile, with the solid electrolyte layer 30 having a thickness of more than 10 μm, the migration distance of lithium ions is lengthened, which leads to a slower charge and discharge speed.

The solid electrolyte layer 30 may have a crystalline structure or a non-crystalline, amorphous structure. The solid electrolyte layer 30 is, however, preferably amorphous because the amorphous structure allows for more isotropic thermal expansion and contraction.

While any known deposition method may be used to manufacture the solid electrolyte layer 30, such as various PVD (physical vapor deposition) and CVD (chemical vapor deposition) methods, it is preferable to use a sputtering method (sputtering) in terms of production efficiency.

### (Negative Electrode Layer)

The negative electrode layer 40 is a solid thin film containing a negative-electrode active material that occludes and releases lithium ions under negative polarity. The negative electrode layer 40 occludes lithium ions during a charge and releases lithium ions during a discharge. Examples of substances contained in the negative electrode layer 40 may include carbon and silicon. In the present embodiment, boron-doped silicon is used as the negative electrode layer 40.

The negative electrode layer 40 may have a thickness of 10 nm or more and 40 μm or less, for example. With the negative electrode layer 40 having a thickness of less than 10 nm, the lithium-ion rechargeable battery 1 obtained therefrom has a too small capacity, which makes the lithium-ion rechargeable battery 1 impracticable. Meanwhile, with the negative electrode layer 40 having a thickness of more than 40 μm, it takes too much time to form the layer, which reduces productivity. The negative electrode layer 40 may, however, have a thickness of more than 40 μm when a large battery capacity is required of the lithium-ion rechargeable battery 1.

The negative electrode layer 40 may have a crystalline structure or a non-crystalline, amorphous structure. The negative electrode layer 40 is, however, preferably amorphous because the amorphous structure allows for more isotropic expansion and contraction when lithium ions are occluded and released.

While any known deposition method may be used to manufacture the negative electrode layer 40, such as various PVD (physical vapor deposition) and CVD (chemical vapor deposition) methods, it is preferable to use a sputtering method (sputtering) in terms of production efficiency.

### (Negative Electrode Collector Layer)

The negative electrode collector layer 50 may be a solid thin film having electron conductivity. As long as these conditions are met, the negative electrode collector layer 50 is not limited to a particular material, and may be made of, for example, a metal such as titanium (Ti), aluminum (Al), copper (Cu), platinum (Pt) and gold (Au), or a conductive material including alloy of these metals.

The negative electrode collector layer 50 may have a thickness of 5 nm or more and 50 μm or less. With a thickness of less than 5 nm, the negative electrode collector layer 50 reduces its current collection capability, which makes the lithium-ion rechargeable battery 1 impracticable. With a thickness of more than 50 μm, it takes too much time to form the negative electrode collector layer 50, which reduces productivity.

While any known deposition method may be used to manufacture the negative electrode collector layer 50, such as various PVD (physical vapor deposition) and CVD (chemical vapor deposition) methods, it is preferable to use a sputtering method (sputtering) or a vacuum vapor deposition method in terms of production efficiency.

### [Method for Fabricating the Lithium-Ion Rechargeable Battery]

A description will now be given of a method for fabricating (manufacturing) the lithium-ion rechargeable battery 1 shown in FIG. 1.

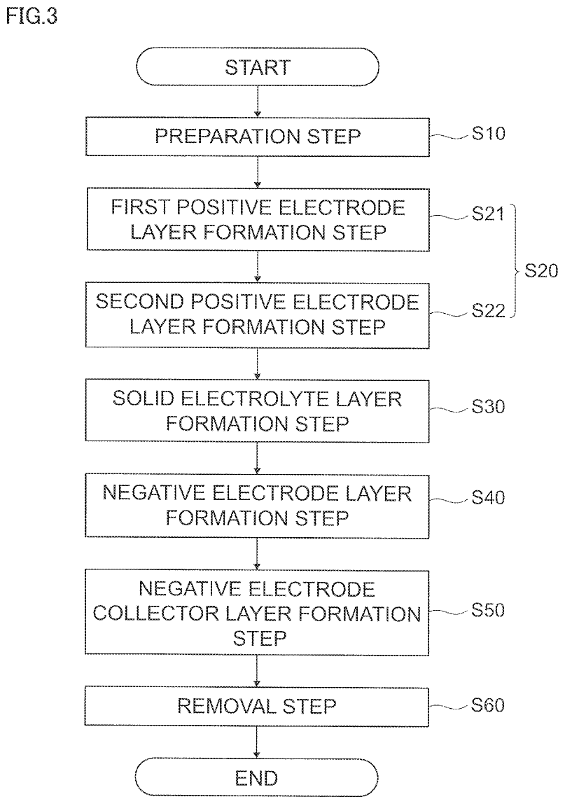

FIG. 3 is a flowchart depicting a method for fabricating the lithium-ion rechargeable battery 1.

Prior to fabrication of the lithium-ion rechargeable battery 1, a preparation step is first performed (step 10), whereby the substrate 10 is prepared and mounted on a sputtering apparatus (not shown in the figure).

Then, a positive electrode layer formation step is performed using the sputtering apparatus (step 20), whereby the positive electrode layer 20 is formed on the substrate 10. In the present embodiment, the positive electrode layer formation step of step 20 consists of a first positive electrode layer formation step (step 21), whereby the first positive electrode layer 21 is formed on the substrate 10, and a second positive electrode layer formation step (step 22), whereby the second positive electrode layer 22 is formed on the first positive electrode layer 21.

A solid electrolyte layer formation step is then performed using the sputtering apparatus (step 30), whereby the solid electrolyte layer 30 is formed on the positive electrode layer 20.

A negative electrode layer formation step is then performed using the sputtering apparatus (step 40), whereby the negative electrode layer 40 is formed on the solid electrolyte layer 30.

A negative electrode collector layer formation step is then performed using the sputtering apparatus (step 50), whereby the negative electrode collector layer 50 is formed on the negative electrode layer 40.

Finally, a removal step is performed (step 60), whereby the lithium-ion rechargeable battery composed by stacking the positive electrode layer 20, the solid electrolyte layer 30, the negative electrode layer 40, and negative electrode collector layer 50 on the substrate 10 is removed from the sputtering apparatus.

Details of the thus-obtained lithium-ion rechargeable battery 1, including its structure and properties, will be explained in Examples given below.

### Second Embodiment

### [Structure of the Lithium-Ion Rechargeable Battery]

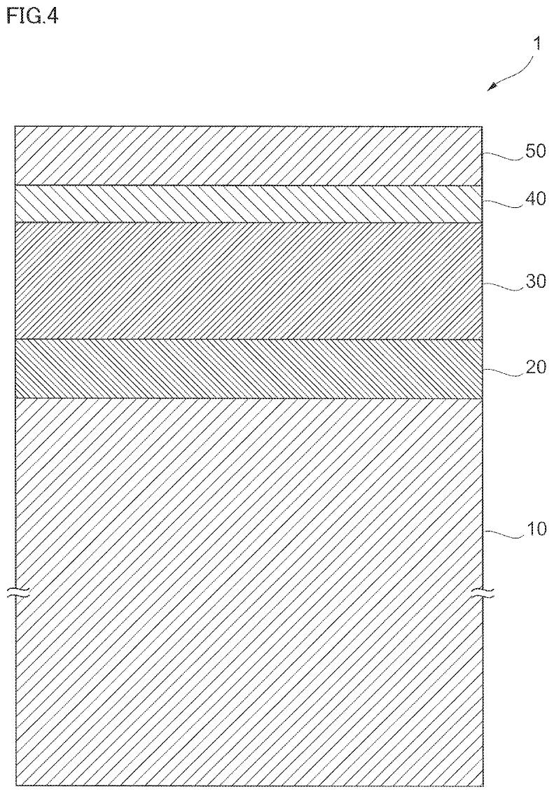

FIG. 4 depicts a cross-sectional structure of the lithium-ion rechargeable battery 1 of the second embodiment.

The basic structure of the lithium-ion rechargeable battery 1 of the present embodiment is almost same as that of the first embodiment, except that the positive electrode layer 20 of the present embodiment is composed of a single layer.

The positive electrode layer 20 of the present embodiment is made of the same material as that of the second positive electrode layer 22 of the lithium-ion rechargeable battery 1 of the first embodiment. That is, the positive electrode layer 20 is made of lithium manganate that has a lithium molar ratio higher than that of the stoichiometric composition.

The positive electrode layer 20 preferably has a thickness of 100 nm or more and 40 μm or less, for example. With the positive electrode layer 20 having a thickness of less than 100 nm, the lithium-ion rechargeable battery 1 obtained therefrom has a too small capacity, which makes the lithium-ion rechargeable battery 1 impracticable. Meanwhile, with the positive electrode layer 20 having a thickness of more than 40 μm, it takes too much time to form the layer, which reduces productivity. The positive electrode layer 20 may, however, have a thickness of more than 40 μm when a large battery capacity is required of the lithium-ion rechargeable battery 1.

The positive electrode layer 20 may have a crystalline structure or a non-crystalline, amorphous structure. The positive electrode layer 20 is, however, preferably amorphous because the amorphous structure allows for more isotropic expansion and contraction when lithium ions are occluded and released.

While any known deposition method may be used to manufacture the positive electrode layer 20, such as various PVD (physical vapor deposition) and CVD (chemical vapor deposition) methods, it is preferable to use a sputtering method (sputtering) in terms of production efficiency.

### [Method for Manufacturing the Lithium-Ion Rechargeable Battery]

The method for manufacturing the lithium-ion rechargeable battery 1 is basically the same as that explained in the first embodiment. The difference from the first embodiment lies in that the positive electrode layer 20 composed of a single layer is formed in the positive electrode layer formation step of step 20.

Details of the thus-obtained lithium-ion rechargeable battery 1, including its structure and properties, will be explained in Examples given below.

### [Others]

In the first and the second embodiments, the positive electrode layer 20, the solid electrolyte layer 30, and the negative electrode layer 40 are stacked in this order on the substrate 10; however, the structure may be changed such that the negative electrode layer 40, the solid electrolyte layer 30, and the positive electrode layer 20 are stacked in this order on the substrate 10.

### EXAMPLES

The present invention will be described in more detail below based on Examples. It should be noted that the present invention is not limited to Examples given below as long as its scope is not exceeded.

The present inventors fabricated multiple lithium-ion rechargeable batteries 1 having different constitutions, and evaluated the thus-obtained lithium-ion rechargeable batteries 1 in regard to the crystalline structure of the positive electrode layer 20 and the discharge capacity.

Tables 1 to 3 show the constitutions of the lithium-ion rechargeable batteries 1 of Examples 1 to 3, respectively. Table 4 shows the constitution of the lithium-ion rechargeable battery 1 of a comparative example.

TABLE 1

| | | CONSTITUTION | | |
|---|---|---|---|---|
| | | | THICK- | |
| EXAMPLE 1 | | COMPO- | NESS | |
| MEMBER | | SITION | (m) | STRUCTURE |
| SUBSTRATE | | SUS304 | 30 μ | CRYSTALLINE |
| POSITIVE | FIRST | Li_{1.5}Mn₂O₄ | 867 n | AMORPHOUS |
| ELECTRODE | POSITIVE | | | + |
| LAYER | ELECTRODE | | | MICRO- |
| | LAYER | | | CRYSTALLINE |
| | SECOND | Li_{2.5}Mn₂O₄ | 100 n | AMORPHOUS |
| | POSITIVE | | | |
| | ELECTRODE | | | |
| | LAYER | | | |

| | | | |
|---|---|---|---|
| SOLID | LiPON | 600 n | AMORPHOUS |
| ELECTROLYTE | | | |
| LAYER | | | |
| NEGATIVE | Si(B) | 100 n | AMORPHOUS |
| ELECTRODE | | | |
| LAYER | | | |
| NEGATIVE | Ti | 200 n | CRYSTALLINE |
| ELECTRODE | | | |
| COLLECTOR | | | |
| LAYER | | | |

TABLE 2

| | CONSTITUTION | | |
|---|---|---|---|
| | | THICK- | |
| EXAMPLE 2 | | NESS | |
| MEMBER | COMPOSITION | (m) | STRUCTURE |
| SUBSTRATE | SUS304 | 30 μ | CRYSTALLINE |
| POSITIVE | Li_{2.5}Mn₂O₄ | 1500 n | AMORPHOUS |
| ELECTRODE | | | |
| LAYER | | | |
| SOLID | LiPON | 600 n | AMORPHOUS |
| ELECTROLYTE | | | |
| LAYER | | | |
| NEGATIVE | Si(B) | 100 n | AMORPHOUS |
| ELECTRODE | | | |
| LAYER | | | |
| NEGATIVE | Ti | 200 n | CRYSTALLINE |
| ELECTRODE | | | |
| COLLECTOR | | | |
| LAYER | | | |

TABLE 3

| | CONSTITUTION | | |
|---|---|---|---|
| | | THICK- | |
| EXAMPLE 3 | | NESS | |
| MEMBER | COMPOSITION | (m) | STRUCTURE |
| SUBSTRATE | SUS304 | 30 μ | CRYSTALLINE |
| POSITIVE | Li_{2.5}MnO₃ | 1500 n | AMORPHOUS |
| ELECTRODE | | | |
| LAYER | | | |
| SOLID | LiPON | 600 n | AMORPHOUS |
| ELECTROLYTE | | | |
| LAYER | | | |
| NEGATIVE | Si(B) | 100 n | AMORPHOUS |
| ELECTRODE | | | |
| LAYER | | | |
| NEGATIVE | Ti | 200 n | CRYSTALLINE |
| ELECTRODE | | | |
| COLLECTOR | | | |
| LAYER | | | |

TABLE 4

| | CONSTITUTION | | |
|---|---|---|---|
| COMPARATIVE | | THICK- | |
| EXAMPLE | | NESS | |
| MEMBER | COMPOSITION | (m) | STRUCTURE |
| SUBSTRATE | SUS304 | 30 μ | CRYSTALLINE |
| POSITIVE | Li_{1.5}Mn₂O₄ | 1000 n | AMORPHOUS + |
| ELECTRODE | | | MICRO- |
| LAYER | | | CRYSTALLINE |
| SOLID | LiPON | 600 n | AMORPHOUS |
| ELECTROLYTE | | | |
| LAYER | | | |
| NEGATIVE | Si(B) | 100 n | AMORPHOUS |
| ELECTRODE | | | |
| LAYER | | | |
| NEGATIVE | Ti | 200 n | CRYSTALLINE |
| ELECTRODE | | | |
| COLLECTOR | | | |
| LAYER | | | |

### Example 1

The lithium-ion rechargeable battery 1 of Example 1 corresponds to that of the above first embodiment (see FIG. 1). Accordingly, the lithium-ion rechargeable battery 1 of Example 1 includes the positive electrode layer 20 composed of the two layers (the first positive electrode layer 21 and the second positive electrode layer 22).

In Example 1, crystalline SUS304 stainless steel was used for the substrate 10. The thickness of the substrate 10 was 30 μm.

In Example 1, amorphous Li_{1.5}Mn₂O₄ was used for the first positive electrode layer 21 constituting the positive electrode layer 20. The thickness of the first positive electrode layer 21 was 867 nm.

In Example 1, amorphous Li_{2.5}Mn₂O₄ was used for the second positive electrode layer 22 constituting the positive electrode layer 20. The thickness of the second positive electrode layer 22 was 100 nm.

In Example 1, LiPON was used for the solid electrolyte layer 30. The thickness of the solid electrolyte layer 30 was 600 nm.

In Example 1, boron (B)-doped amorphous silicon (Si) was used for the negative electrode layer 40. In Table 1, it is denoted as Si(B). The thickness of the negative electrode layer 40 was 100 nm.

In Example 1, crystalline titanium (Ti) was used for the negative electrode collector layer 50. The thickness of the negative electrode collector layer 50 was 200 nm.

### Example 2

The lithium-ion rechargeable battery 1 of Example 2 corresponds to that of the above second embodiment (see FIG. 4). Accordingly, the lithium-ion rechargeable battery 1 of Example 2 includes the positive electrode layer 20 composed of the single layer.

The constitution of the lithium-ion rechargeable battery 1 of Example 2 is the same as that of Example 1, except for the positive electrode layer 20. Thus, detailed description of the substrate 10, the solid electrolyte layer 30, the negative electrode layer 40, and the negative electrode collector layer 50 of Example 2 will be omitted.

In Example 2, amorphous Li_{2.5}Mn₂O₄ (the same material as that for the second positive electrode layer 22 of Example 1) was used for the positive electrode layer 20. The thickness of the positive electrode layer 20 was 1500 nm.

### Example 3

The lithium-ion rechargeable battery 1 of Example 3 is the same as that of Example 2, except that amorphous Li_{2.5}MnO₃ was used for the positive electrode layer 20.

### COMPARATIVE EXAMPLE

The lithium-ion rechargeable battery 1 of the comparative example includes the positive electrode layer 20 composed of the single layer, similarly to Example 2 explained above. The positive electrode layer 20 of the comparative example is, however, made of a material different from that in Example 2.

The constitution of the lithium-ion rechargeable battery 1 of the comparative example is the same as that of Example 1 and Example 2, except for the positive electrode layer 20. Thus, detailed description of the substrate 10, the solid electrolyte layer 30, the negative electrode layer 40, and the negative electrode collector layer 50 of the comparative example will be omitted.

In the comparative example, amorphous Li_{1.5}Mn₂O₄ (the same material as that for the first positive electrode layer 21 of Example 1) was used for the positive electrode layer 20. The thickness of the positive electrode layer 20 was 1000 nm.

### [Method for Manufacturing Each Lithium-Ion Rechargeable Battery]

The lithium-ion rechargeable batteries 1 of Examples 1 to 3 and the comparative example were each obtained by depositing the positive electrode layer 20, the solid electrolyte layer 30, the negative electrode layer 40, and the negative electrode collector layer 50 in this order on the substrate 10 using the sputtering method. During deposition of the positive electrode layer 20, the solid electrolyte layer 30, the negative electrode layer 40, and the negative electrode collector layer 50 on the substrate 10, temperature of the substrate 10 was kept lower than 300° C.

In the lithium-ion rechargeable batteries 1 of Examples 1 to 3 and the comparative example, the size of the substrate 10 was 50 mm×50 mm. The size of both of the positive electrode layer 20 and the solid electrolyte layer 30 was 10 mm×10 mm. The size of both of the negative electrode layer 40 and the negative electrode collector layer 50 was 8 mm×8 mm.

### [Evaluation of the Lithium-Ion Rechargeable Batteries]

As a measure to evaluate the lithium-ion rechargeable batteries 1 of Examples 1 to 3 and the comparative example, the crystalline structure and composition of the positive electrode layer 20 constituting each lithium-ion rechargeable battery 1, and internal resistance and discharge capacity of each lithium-ion rechargeable battery 1 were measured.

### (Crystalline Structure of the Positive Electrode Layer)

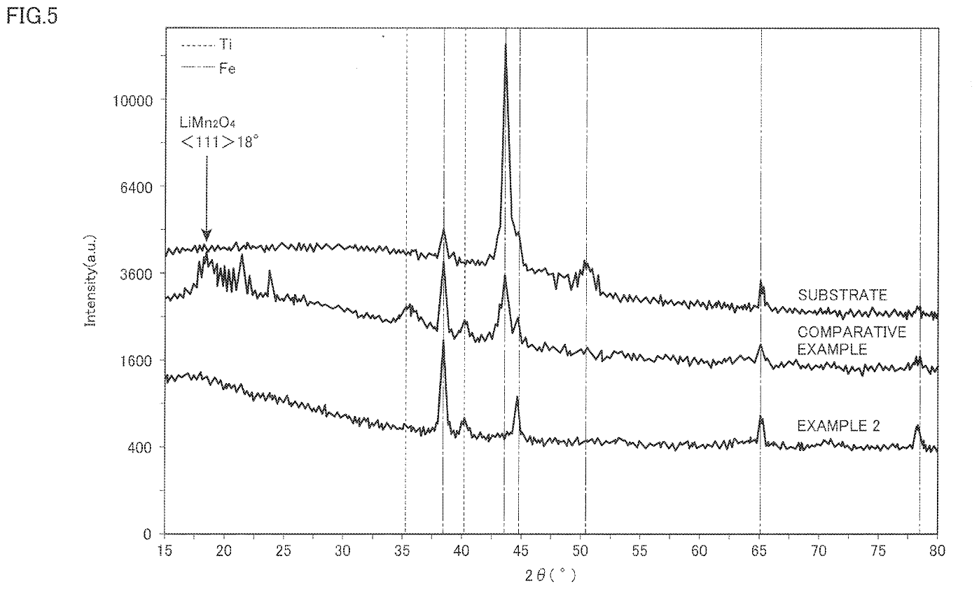

FIG. 5 depicts X-ray diffraction (XRD) patterns of the lithium-ion rechargeable batteries 1 of Example 2 and the comparative example and the substrate 10 (SUS304). In FIG. 5, the horizontal axis represents diffraction angle 2θ(°), and the vertical axis represents the diffraction strength (a.u.).

The X-ray diffraction pattern of the substrate 10 will be explained.

The substrate 10 is observed to have intensity peaks at around 2θ=38°, 43°, 45°, 50°, 65°, and 78°. This is considered attributable to iron (Fe) in SUS304, which constitutes the substrate 10.

The X-ray diffraction pattern of the lithium-ion rechargeable battery 1 of Example 2 will be explained.

In addition to those attributable to iron (Fe) as described above, the lithium-ion rechargeable battery 1 of Example 2 is observed to have intensity peaks at around 2θ=35° and 40°. This is attributable to titanium (Ti) constituting the negative electrode collector layer 50. As such, the lithium-ion rechargeable battery 1 of Example 2 has no intensity peaks other than those attributable to iron (Fe) and titanium (Ti) and exhibits a broad halo pattern. This suggests that the positive electrode layer 20 is amorphous. This also suggests that the solid electrolyte layer 30 and the negative electrode layer 40 are amorphous.

The X-ray diffraction pattern of the lithium-ion rechargeable battery 1 of the comparative example will be explained.

In addition to those attributable to iron (Fe) and titanium (Ti) as described above, the lithium-ion rechargeable battery 1 of the comparative example is observed to have an intensity peak at around 2θ=18°. This is attributable to LiMn₂O₄<111> constituting the positive electrode layer 20. As such, the lithium-ion rechargeable battery 1 of the comparative example has no intensity peaks other than those attributable to iron (Fe), titanium (Ti), and LiMn₂O₄<111> and exhibits a broad halo pattern. This suggests that the positive electrode layer 20 is amorphous with microcrystalline LiMn₂O₄. This also suggests that the solid electrolyte layer 30 and the negative electrode layer 40 are amorphous.

Note that the X-ray diffraction pattern of the lithium-ion rechargeable battery 1 of Example 1 is thought to be a superposition of the X-ray diffraction patterns of Example 2 and the comparative example. This is because the positive electrode layer 20 of the comparative example and the positive electrode layer 20 of Example 2 correspond to the first positive electrode layer 21 and the second positive electrode layer 22, respectively, of the lithium-ion rechargeable battery 1 of Example 1.

### (Composition of the Positive Electrode Layer)

To investigate the composition of the positive electrode layer 20, a sample composed of a copper foil and the positive electrode layer 20 of Example 2 formed thereon and a sample composed of a copper foil and the positive electrode layer 20 of the comparative example formed thereon were prepared. Fabrication conditions for the former sample and the latter sample were the same as those for the lithium-ion rechargeable batteries 1 of Example 2 and the comparative example, respectively. In the following explanation, the former sample is referred to as a sample of Example 2, and the latter sample is referred to as a sample of the comparative example, for the purpose of convenience.

The thus-obtained samples of Example 2 and the comparative example and commercially available, crystalline power standard samples (Li₂Mn₂O₄ and LiMn₂O₄: 6 to 8 mg) were each added with nitric acid (1+1) and hydrochloric acid (1+1), and then heated and dissolved. The volume of the thus-obtained solutions was each fixed at 50 ml before they were diluted 25 times. These solutions were then subjected to ICP-AES (Inductively coupled plasma atomic emission spectroscopy) to measure lithium (Li) and manganese (Mn) and calculate their molar ratio.

Each of the commercially available, crystalline power standard samples of Li₂Mn₂O₄ and LiMn₂O₄ was evaluated twice using the above method. The results showed that the former sample exhibited the ratio of Li:Mn=2.0:2.0 (in both of the two evaluations) and the latter sample exhibited the ratio of Li:Mi=0.98:2.0 in the first evaluation and Li:Mn=0.96:2.0 in the second evaluation, proving the adequacy of the above method to evaluate the Li:Mn molar ratio. Note that the molar ratio to oxygen could not be evaluated under the above method. The results of evaluation of the sample of Example 2 showed that it exhibited Li:Mn ratio of 2.5:2, and the results of evaluation of the sample of Example 3 showed that it exhibited Li:Mn ratio of 2.5:1. Also, the results of evaluation of the sample of the comparative example showed that it exhibited Li:Mn ratio of 1.5:2.

From the above, it was identified that each of the second positive electrode layer 22 of Example 1 and the positive electrode layer 20 of Example 2 is a non-crystalline film composed of Li_{2.5}Mn₂O₄ with a lithium molar ratio higher than that of the stoichiometric composition. Also, it was identified that the positive electrode layer 20 of Example 3 is a film composed of Li_{2.5}MnO₃ with a lithium molar ratio higher than that of the stoichiometric composition. This characteristic constitution of the films is thought to be contributing to reduced internal resistance and increased discharge capacity of the lithium-ion rechargeable battery 1, which will be described below. Note that the first positive electrode layer 21 of Example 1 is thought to be a non-crystalline film composed of Li_{1.5}Mn₂O₄ with microcrystalline LiMn₂O₄.

### (Internal Resistance and Discharge Capacity)

A charge-discharge cycle test was conducted on each of the lithium-ion rechargeable batteries 1 of Examples 1 and 2 and the comparative example to evaluate their internal resistance and discharge capacity. The measuring instrument used was HJ1020mSD8 charge-discharge device from Hokuto Denko Corporation. In the charge-discharge cycle test, each lithium-ion rechargeable battery 1 was charged at a constant current (3 μA) until reaching an upper limit voltage (4.3 V), and upon reaching the upper limit voltage, the circuit was opened for 10 seconds and an open circuit voltage (OCV) was thus measured. Upon completion of measurement of the open circuit voltage, each lithium-ion rechargeable battery 1 was discharged at the constant current (3 μA) until reaching a lower limit voltage (0.5 V), and upon reaching the lower limit voltage, the circuit was opened for 10 seconds. The above charge-discharge procedure was repeated three times (three cycles). Note that the upper limit voltage for the lithium-ion rechargeable battery 1 of Example 3 was set to 5.0 V.

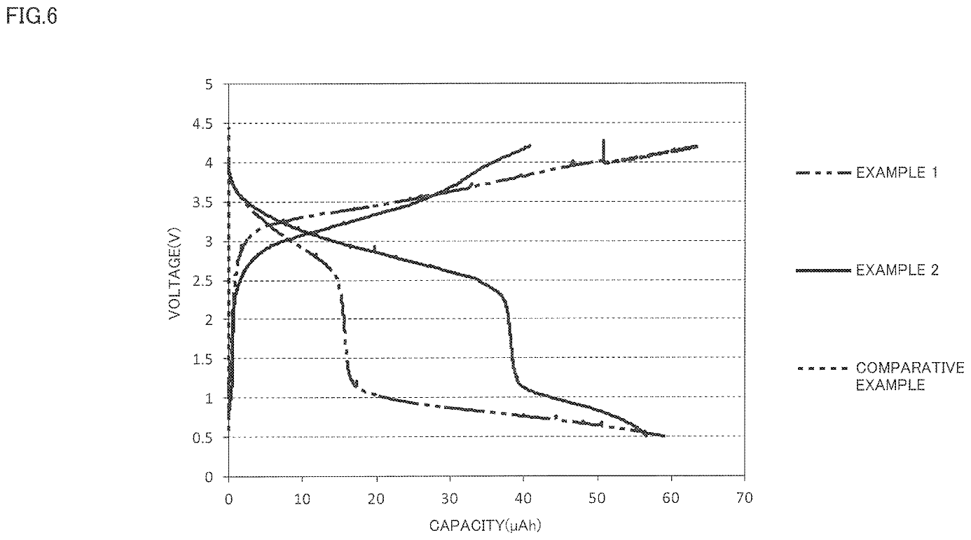

FIG. 6 depicts charge-discharge curves of the lithium-ion rechargeable batteries 1 of Example 1, Example 2, and the comparative example. In FIG. 6, the horizontal axis represents the capacity (μAh) of each lithium-ion rechargeable battery 1, and the vertical axis represents the voltage (V) of each lithium-ion rechargeable battery 1. Table 5 shows the open circuit voltage (V) and the discharge capacity (μAh) of the lithium-ion rechargeable batteries 1 of Example 1, Example 2, and the comparative example after repeating the charge and discharge three times.

TABLE 5

| | | POSITIVE | | |
|---|---|---|---|---|
| | POSITIVE | ELECTRODE | | |
| | ELECTRODE | LAYER | DISCHARGE | |
| | LAYER | THICKNESS | CAPACITY | OCV |
| | COMPOSITION | (nm) | (μAh) | (V) |
| EXAMPLE 1 | Li_{1.5}Mn₂O₄/ | 867/100 | 59.1 | 4.04 |
| | Li_{2.5}Mn₂O₄ | | | |
| EXAMPLE 2 | Li_{2.5}Mn₂O₄ | 1500 | 56.4 | 3.96 |
| EXAMPLE 3 | Li_{2.5}MnO₃ | 1500 | 50.2 | 4.43 |
| COMPAR- | Li_{1.5}Mn₂O₄ | 1000 | 0.001 | 1.24 |
| ATIVE | | | | |
| EXAMPLE | | | | |

The discharge capacity will be explained first. The results of the above charge-discharge cycle test showed that the discharge capacity of Example 1 was 59.1 (μAh), the discharge capacity of Example 2 was 56.4 (μAh), and the discharge capacity of Example 3 was 50.2 (μAh). On the other hand, the discharge capacity of the comparative example was 0.001 (μAh). This means that a high internal resistance region occurred in the lithium-ion rechargeable battery 1 of the comparative example, which caused it to reach the upper limit voltage with an insufficient charge, resulting in a considerable decrease in its discharge capacity. Comparing Example 1 and Example 2, it was found that the lithium-ion rechargeable battery 1 of Example 1 had a larger discharge capacity than Example 2. The reason for this is probably that the first positive electrode layer 21 was made of Li_{1.5}Mn₂O₄ having a lithium molar ratio lower than that of the stoichiometric composition and this increased Li ionic vacancies inside the positive electrode layer 20 and thus increased its Li ionic conductivity.

Then, the open circuit voltage will be explained. The results of the above charge-discharge cycle test showed that the open circuit voltage of Example 1 was 4.04(V), the open circuit voltage of Example 2 was 3.96 (V), and the open circuit voltage of Example 3 was 4.43 (V). On the other hand, the open circuit voltage of the comparative example was 1.24 (V). Here, a correlation exists between the internal resistance and the open circuit voltage of the lithium-ion rechargeable battery 1; the open circuit voltage reduces with increase in the internal resistance, and the open circuit voltage increases with decrease in the internal resistance. It was thus found that the lithium-ion rechargeable batteries 1 of Examples 1 to 3 had a lower internal resistance than that of the lithium-ion rechargeable battery 1 of the comparative example. Also, comparing Example 1 and Example 2, the lithium-ion rechargeable battery 1 of Example 1 was found to have a higher open circuit voltage (i.e., a lower internal resistance).

The lithium-ion rechargeable batteries 1 of Examples 1 to 3 are less prone to internal short circuit than the lithium-ion rechargeable battery 1 of the comparative example. This is probably because each of the lithium-ion rechargeable batteries 1 of Examples 1 to 3 uses the Li-rich positive electrode layer 20 at the interface between the positive electrode layer 20 and the solid electrolyte layer 30.

### REFERENCE SIGNS LIST

1 Lithium-ion rechargeable battery
10 Substrate
20 Positive electrode layer
21 First positive electrode layer
22 Second positive electrode layer
30 Solid electrolyte layer
40 Negative electrode layer
50 Negative electrode collector layer

1-11. (canceled)

12. A lithium-ion rechargeable battery comprising, in the following order:
a positive electrode layer containing lithium, manganese and oxygen, the positive electrode layer having a lithium molar ratio higher than a lithium molar ratio of a stoichiometric composition, the positive electrode layer occluding and releasing lithium ions;
an electrolyte layer containing an electrolyte that exhibits lithium ionic conductivity; and
a negative electrode layer occluding and releasing lithium ions under a polarity opposite to a polarity of the positive electrode layer.

13. The lithium-ion rechargeable battery according to claim 12, wherein, in the positive electrode layer, lithium is at a higher molar ratio to manganese.

14. The lithium-ion rechargeable battery according to claim 12, wherein the positive electrode layer has an amorphous structure.

15. The lithium-ion rechargeable battery according to claim 13, wherein the positive electrode layer has an amorphous structure.

16. A lithium-ion rechargeable battery comprising, in the following order:
a positive electrode layer containing lithium, manganese and oxygen, the positive electrode layer occluding and releasing lithium ions;
an electrolyte layer containing an electrolyte that exhibits lithium ionic conductivity; and
a negative electrode layer occluding and releasing lithium ions under a polarity opposite to a polarity of the positive electrode layer, wherein
a molar ratio of lithium to manganese in a portion of the positive electrode layer facing the electrolyte layer is higher than a molar ratio of lithium to manganese in another portion of the positive electrode layer not facing the electrolyte layer.

17. The lithium-ion rechargeable battery according to claim 16, wherein a lithium molar ratio in the portion of the positive electrode layer facing the electrolyte layer is higher than a lithium molar ratio of a stoichiometric composition.

18. A lithium-ion rechargeable battery comprising, in the following order:
a positive electrode layer including a first positive electrode layer and a second positive electrode layer, the first positive electrode layer containing lithium, manganese and oxygen, the second positive electrode layer containing lithium, manganese and oxygen with a different composition from the first positive electrode layer, the positive electrode layer occluding and releasing lithium ions;
an electrolyte layer provided on the second positive electrode layer of the positive electrode layer, the electrolyte layer containing an electrolyte exhibiting lithium ionic conductivity; and
a negative electrode layer occluding and releasing lithium ions under a polarity opposite to a polarity of the positive electrode layer, wherein
the second positive electrode layer has a lithium molar ratio higher than a lithium molar ratio of a stoichiometric composition.

19. The lithium-ion rechargeable battery according to claim 18, wherein, in the second positive electrode layer, lithium is at a higher molar ratio to manganese.

20. The lithium-ion rechargeable battery according to claim 18, wherein a molar ratio of lithium to manganese in the second positive electrode layer is higher than a molar ratio of lithium to manganese in the first positive electrode layer.

21. The lithium-ion rechargeable battery according to claim 19, wherein a molar ratio of lithium to manganese in the second positive electrode layer is higher than a molar ratio of lithium to manganese in the first positive electrode layer.

22. The lithium-ion rechargeable battery according to claim 18, wherein the first positive electrode layer has a lithium molar ratio lower than the lithium molar ratio of a stoichiometric composition.

23. The lithium-ion rechargeable battery according to claim 19, wherein the first positive electrode layer has a lithium molar ratio lower than the lithium molar ratio of a stoichiometric composition.

24. The lithium-ion rechargeable battery according to claim 20, wherein the first positive electrode layer has a lithium molar ratio lower than the lithium molar ratio of a stoichiometric composition.

25. The lithium-ion rechargeable battery according to claim 21, wherein the first positive electrode layer has a lithium molar ratio lower than the lithium molar ratio of a stoichiometric composition.

26. A positive electrode active material containing lithium, manganese, and oxygen, and having a lithium molar ratio higher than a lithium molar ratio of a stoichiometric composition.

27. The positive electrode active material according to claim 26, wherein, in the positive electrode active material, lithium is at a higher molar ratio to manganese.
